(19) United States
(12) Patent Application Publication
(10) Pub. No.: US 2017/0228274 A1
(43) Pub. Date: Aug. 10, 2017

(54) SYSTEM FOR LIMITING FAULTS ASSOCIATED WITH A RANDOM SAMPLING SIMULATION METHOD FOR OBTAINING NUMERIC VALUES

(71) Applicant: BANK OF AMERICA CORPORATION, Charlotte, NC (US)

(72) Inventor: Steven Anthony Guccione, Austin, TX (US)

(21) Appl. No.: 15/040,792

(22) Filed: Feb. 10, 2016

(51) Int. Cl. G06F 11/07

(52) U.S. Cl. CPC G06F 11/079; G06F 11/0751

(57) ABSTRACT

The present invention provides for systems and the like for limiting faults, otherwise referred to as errors, and in some instances eliminating faults, that exist within a random sampling simulation method for determining numeric results, such as, for example, the Monte Carlo method. The present invention provides for detecting faults during the simulation process prior to determining the estimated numerical value of an equation without using a closed-form solution. Specifically, filtering out determined intermediary numerical values, which are subsequently the basis for the estimated numerical value, that are outside of a predetermined range, for example a predetermined number of standard deviations away from the averaging of historical estimated numerical values.

### FIELD

In general, embodiments of the invention relate to fault tolerance and, more specifically, for limiting faults associated with a random sampling simulation method for obtaining numeric values, such as, the Monte Carlo simulation method or the like.

### BACKGROUND

Silicon technology is beginning to push up against the limits of fault-free operation. As transistors continue to shrink, transistor counts continue to increase and as voltages continue to drop, the presence of faults (otherwise referred to herein as errors), both of a transient and permanent nature, will challenge the way semiconductor devices are manufactured and the way computation is performed. In this regard, faults may become more common as more transistors are formed from a single die. Additionally, other factors in silicon technology, such as process variation and the like, may increase the occurrence of faults. Moreover, analysis and testing for faults is often a difficult and, in certain instances, not a viable solution.

Processors with improved fault tolerance are readily available, but have typically been limited to high reliability applications, such as military, avionics, medical and the like. For example, the military and avionics industries implement Triple Modular Redundancy (TMR), which utilizes a voting scheme for correctness of faults. However, such redundancy significantly increases the size and cost of the processors.

Today, most commercial consumer processors ignore the possibility of faults, in spite of the increasing likelihood. Server systems often use fault tolerant memory with Error Correcting Codes (ECC) and some limited internal fault tolerance. ECC relies on redundant information being used to transfer data, as such, the communication is slower and larger and more complex hardware is required. In addition, ECC is typically limited to single error correction and double error detection and only detects communication errors (i.e., does not detect calculation errors). Moreover, ECC has proven to be difficult to use in many applications.

Additionally, fault tolerance exists in other specific circuits, for example, memory devices may implement spare rows and/or columns, flash memory may employ Bad Block Management (BBM), multicore Central Processing Units (CPUs) and Graphics Processing Units (GPUs) may include spare cores and the like.

However, in general, most internal circuitry in commercial computing devices, otherwise referred to as general circuity, does not use redundancy, ECC or any other fault protection mechanism. In this regard, faults are viewed as being tolerated in most internal commercial circuitry. This is because commercial applications typically demand less expensive hardware. In addition, fault tolerance allows for larger devices to be manufactured that push environmental and performance factors, such as, higher clock speeds, higher temperatures, lower power and/or voltage and the like. Additionally, fault tolerance allows for the use of simpler networking protocols.

Therefore, a need exists to develop a simplistic and cost efficient means for limiting faults, and in some instances eliminating the faults, associated with a random sampling method for determining numeric results, such as the Monte Carlo method or the like. The desired solution should provide accurate numeric results in the presence of faults. Moreover, the desired solution should be made possible without redundant hardware and, thus, introduce minimal additional overhead into the fault protection process.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, systems, computer program products, methods or the like for limiting faults that occur during a random sampling simulator method, which is used for obtaining an estimated numeric solution for an equation without using a closed-form solution. In specific embodiments of the invention the random sampling simulator method relies on the Monte Carlo method for obtaining the numeric result. According to embodiments of the invention, faults are detected prior to random sampling simulator method determining the final numeric result (i.e., the estimated solution for the equation). In specific embodiments of the invention such detection of faults is determined by filtering out the streaming intermediary numeric values (i.e., the values used to determine the final numeric value) based on values being outside of a predetermined range. In specific embodiments of the invention, the predetermined range is defined as a predetermined number of standard deviations derived from averaging of historical final numeric values (i.e., previous random sampling simulator method runs). By filtering out the faults prior to determining the final numeric value, the resulting final numeric value is a more accurate estimated solution for the equation. Such accuracy is especially apparent in those equations that rely on floating point calculations, in which, the occurrence of a fault may result in intermediary numeric values that are magnitudes in error in comparison to the average final numeric value.

A system for detecting faults associated with random sampling to obtain a numeric value defines first embodiments of the invention. The system includes a computing platform (i.e., typically multiple computing device) having a memory and at least one processor in communication with the memory. Additionally, the system includes a numeric value simulator module that is stored in the memory and executable by the processor. In specific embodiments, the numeric value simulator module is further defined as a Monte Carlo method simulator module. The numeric value simulator module is configured to receive a plurality of randomly generated numerical input parameters and apply the plurality of randomly generated numerical input parameters to one or more computational algorithms to determine a plurality of intermediary numeric values. In addition, the module is configured to determine a final numeric value based on the plurality of intermediary numeric values. The final numeric value is an estimated value for an equation without using a closed-form solution. The system additionally includes a fault detection routine that is stored in the memory and executable by the processor. In specific embodiments of the invention, the functionality of the fault detection routine is included within the numeric value simulator module, obviating the need for a separate fault detection routine. The fault detection routine is configured to determine that one or more of the plurality of intermediary numeric values are outside of a predetermined range. Each of the intermediary numeric values that are outside of a predetermined range define a fault.

In specific embodiments of the system, the fault detection routine is further configured to filter out the determined intermediary numeric values prior to determining the final numeric value. In specific embodiments of the invention, the predetermined range is based on a predetermined number of standard deviations from a historical averaging of final numeric values. In specific embodiments of the system, the predetermined number of standard deviations is less than or equal to five standard deviations, such as between three to five standard deviations, and in one specific embodiment, five standard deviations.

In specific embodiments of the system, the system is employed to determine an estimate price for a predetermined financial option, specifically the put and/or call price for a financial option. In such embodiments of the invention, the input parameters are parameters that effect pricing of a predetermined financial options and the final numeric value is further defined as an estimated price for the predetermined financial option. In other specific embodiments the system includes a financial option transaction module that is stored in the memory and executable by the processor. The transaction module is configured to, in automatic response to determining the estimated price for the predetermined financial option, conduct a sale of the financial option based on the estimated price for the predetermined financial option.

In still further specific embodiments the system includes a detected fault database that is configured to, in response to determining that one or more of the plurality of intermediary numeric values are outside of the predetermined range, receive and store information associated the one or more of the plurality of intermediary numeric values that are outside of the predetermined range. In such embodiments the system may further include a fault-related reporting module stored in the memory, executable by the processor and configured to access the detected fault database to retrieve the information and generate and initiate electronic communication of a plurality of graphical data based on the information.

In yet other embodiments of the invention, the system includes a fault analysis module that is stored in the memory and executable by the processor. The fault analysis module is configured to receive results from the numeric value simulator module and the fault detection routine, including, for each process conducted by the numeric value simulator module, the intermediary numeric values that are outside of the predetermined range (i.e., the faults). The fault analysis module is further configured to analyze the results to determine one or more trends in the intermediary numeric values that are outside of the predetermined range. In such embodiments of the system, the fault analysis module may be further configured to determine a fault type (e.g., a communication network fault, a hardware fault, a human error fault or the like) based on at least one of the one or more trends in the intermediary numeric values that are outside of the predetermined range. In other specific embodiments of the system, the fault analysis module is further configured to analyze the results to determine a fault source (e.g., a specific computing device or device component) for at least one of the intermediary numeric values that are outside of the predetermined range, wherein the fault source comprises a specific computing device used by the numeric value simulator module.

A method for detecting faults associated with random sampling to obtain a numeric value defines second embodiments of the invention. The method includes receiving, by a computing device processor, a plurality of randomly generated numerical input parameters and applying, by a computing device processor, one or more computational algorithms to the plurality of randomly generated numerical input parameters to determine a plurality of intermediary numeric values. In specific embodiments of the method, the computational algorithms are Monte Carlo method computational algorithms. The method further includes determining, by a computing device processor, one or more of the plurality of intermediary numeric values that are outside of a predetermined range. Each of the intermediary numeric values that are outside of a predetermined range define a fault. The method further includes determining, by a computing device processor, a final numeric value based on the plurality of intermediary numeric values. The final numeric value is an estimated value for an equation without using a closed-form solution.

In specific embodiments the method further includes, filtering, by a computing device processor, the determined one or more of the plurality of intermediary numeric values prior to determining the final numeric value, such that the determination of the final numeric value is not based on the intermediary numeric values that are determined to be outside of the predetermined range.

In further specific embodiments of the method, the predetermined range is based on a predetermined number of standard deviations from a historical averaging of final numeric values. In specific embodiments of the method, the predetermined number of standard deviations is less than or equal to five standard deviations, such as between three to five standard deviations, and in one specific embodiment, five standard deviations.

A computer program product including a non-transitory computer-readable medium defines third embodiments of the present invention. The computer-readable medium includes a first set of codes for causing a computer to receive a plurality of randomly generated numerical input parameters and a second set of codes for causing a computer to apply the plurality of randomly generated numerical input parameters to one or more computational algorithms to determine a plurality of intermediary numeric values. In specific embodiments of the computer program product, the computational algorithms are Monte Carlo method computational algorithms. Additionally, the computer-readable medium includes a third set of codes for causing a computer to determine, one or more of the plurality of intermediary numeric values that are outside of a predetermined range. Each of the intermediary numeric values that are outside of a predetermined range define a fault. In addition, the computer-readable medium includes a fourth set of codes for causing a computer to determine a final numeric value based on the plurality of intermediary numeric values. The final numeric value is an estimated value for an equation without using a closed-form solution.

In specific embodiments of the computer program product, the computer-readable medium includes a fourth set of codes for causing a computer to filter out the determined one or more of the plurality of intermediary numeric values prior to determining the final numeric value.

In other specific embodiments of the computer program product, the predetermined range is based on a predetermined number of standard deviations from a historical averaging of final numeric values. In specific embodiments of the method, the predetermined number of standard deviations is less than or equal to five standard deviations, such as between three to five standard deviations, and in one specific embodiment, five standard deviations.

Thus, systems, apparatus, methods, and computer program products herein described in detail below provide for a simplistic and cost efficient means for limiting faults (i.e., errors), and in some instances eliminating the faults, associated with a random sampling method for determining numeric results, such as the Monte Carlo method or the like. The embodiments herein described below result in more accurate numeric results. Moreover, embodiments herein described lessen and/or eliminate faults without redundant hardware and, thus, introduce minimal additional overhead into the fault protection process.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a schematic diagram of an exemplary system for detecting and filtering faults that occur during a numeric value simulation, in accordance with embodiments of the present invention;

FIG. 2 provides a block diagram of an apparatus for detecting and filtering faults that occur during a numeric value simulation, in accordance with embodiments of the present invention;

FIG. 3 provides a graphical representation of coordinates on a x-y graph representing the streaming intermediary values outputted in a numeric value simulation for calculating pi (π), in accordance with embodiments of the present invention; and

FIG. 4 provides a graphical representation of coordinates on a x-y graph representing streaming intermediary values outputted in a numeric value simulation for calculating pi (π) and including arrows representing faults in the intermediary values, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention, various systems, apparatus, methods, and computer program products are herein described that provide for a simplistic and cost efficient approach for limiting faults (i.e., errors), and in some instances eliminating the faults, associated with a random sampling simulation method for determining numeric results, such as the Monte Carlo method or the like. By lessening or eliminating faults/errors, the present invention results in a more accurate estimate of the determined numeric result. Moreover, by implementing fault reduction within the random sampling simulation method, such as within the Monte Carlo method, the present invention avoids using redundant hardware or other cost prohibitive means into the fault protection/prevention process.

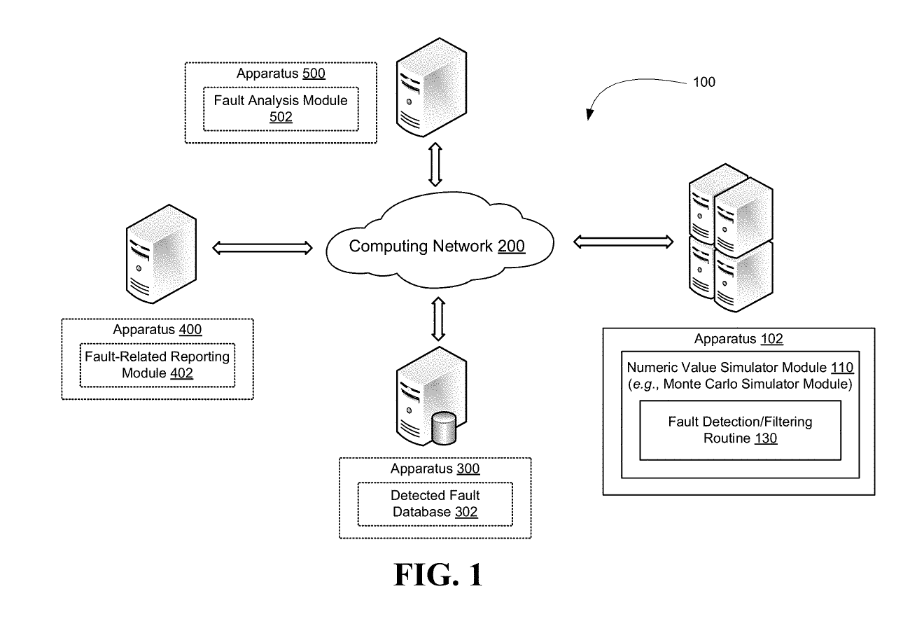

Referring to FIG. 1, a schematic diagram is provided of a system 100 for detecting and, in some embodiments, limiting or eliminating faults associated with random sampling simulation, in accordance with embodiments of the present invention. The system includes a computing network 200, such as the Internet, an intranet, a combination thereof or the like that is configured to communicate data between the various apparatus and databases of system 100. The system further includes apparatus 102, which may comprise multiple computing devices, such as multiple servers or the like. The apparatus 102 is configured to store/access and execute numeric value simulator module 100, which applies one or more computational algorithms to randomly generated numeric input parameters to generate a stream of intermediary numeric values. The intermediary numeric values are then used to determine, such as be averaging or the like, a final numeric value that is the estimated numeric solution for an equation without using a closed-form solution. In specific embodiments of the invention, the numeric value simulator module 100 is a Monte Carlo simulator module.

The module 100 includes fault detection routine 130 that is configured to detect that one or more intermediary values outputted by the computational algorithm(s) are outside of a predetermined range. Each of the intermediary values that are outside of the predetermined range are defined as faults, otherwise referred to herein as errors. In specific embodiments of the system, the fault detection routine 130 is further configured to filter out, prior to determining the final numeric value, the one or more intermediary values that are outside of the predetermined range. In such embodiments, in which the faults are filtered out prior to determine the final numeric value, the final numeric value is a more accurate estimate of the solution of the equation.

In specific embodiments of the invention, the predetermined range implemented by the fault detection routine 130 is a predetermined number of standard deviations from a historical averaging of previously calculated numeric values (i.e., results of previous simulations). In such embodiments of the invention, the number of standard deviations is selected based on the equation for which the solution is sought and is selected so as to insure that any intermediary value that is filtered out is, in fact, a fault. In specific embodiments of the invention, the predetermined number of standard deviations may be five or less, typically between three and five and, in one embodiment, five.

In other specific embodiments of the invention, in which the numeric value simulator module is implemented as a means to determine a price for a financial product, such as financial option (i.e., put and/or call) or the like, the randomly generated numeric input parameters may be parameters that effect pricing of a predetermined financial options. In such embodiments of the invention, the numeric input parameters may be randomly generated by a Black-Scholes model or the like. In specific embodiments of the invention, the system 100 includes a financial product sale module (not shown in FIG. 1) which is configured to, in response to the simulator module 110 determining a price for the financial product, such as an option or the like, automatically conduct a sale of the financial product using the determined estimated price.

In specific embodiments the system 100 additionally includes apparatus 300, which may comprise one or more server databases or the like. Apparatus 300 stores detected fault database 302 that is configured to receive, from apparatus 102, information associated with the faults (i.e., information associated with the one or more intermediary values determined to be outside of the predetermined range). The information may include, but is not limited to, the values of the detected fault(s), the numeric value simulation/run associated with the detected fault(s), the time/date of the numeric value simulation/run and the like.

In other specific embodiments the system 100 additionally includes apparatus 400 which is configured to store/access and execute a fault-related reporting module 402. The fault-related reporting module 402 is configured to access the detected fault database 302 retrieve the information associated with the faults and generate and initiate electronic communication of a fault-related data including, but not limited to, graphical data and or predetermined and/or dynamic reports and/or alerts.

Additionally, in other specific embodiments the system 100 includes apparatus 500, which is configured to store access fault analysis module 502. Fault analysis module 502 may be configured to receive results from the numeric value simulator module and/or access detected fault database 302 to retrieve detected fault results and analyze the results to determine one or more trends in the faults (i.e., intermediary numeric values that are outside of the predetermined range). For example, an upward trend in the number of faults occurring in a same numeric value simulation may indicate a problem/defect with a computing device and/or a specific component in a computing device. As such, fault analysis module 502 may be configured to determine a fault type based on at least one of the one or more fault trends. Fault types include but are not limited to communication network fault, a hardware fault, a human error/data entry fault or the like. In other related embodiments, fault analysis module is configured to receive the results from the numeric value simulator module and/or access detected fault database 302 to retrieve detected fault results and analyze the results to determine a fault source for the faults. The fault source comprises a specific computing device (i.e., apparatus or component) used by the numeric value simulator module and/or a network device.

It should be noted that while the modules and databases shown in FIG. 1 are stored and/or accessed from separate apparatus 100, 300, 400 and 500, according to other embodiments of the invention, the modules and/or databases can be combined, such that, two or more of the modules and/or databases can be included in a single apparatus or the like.

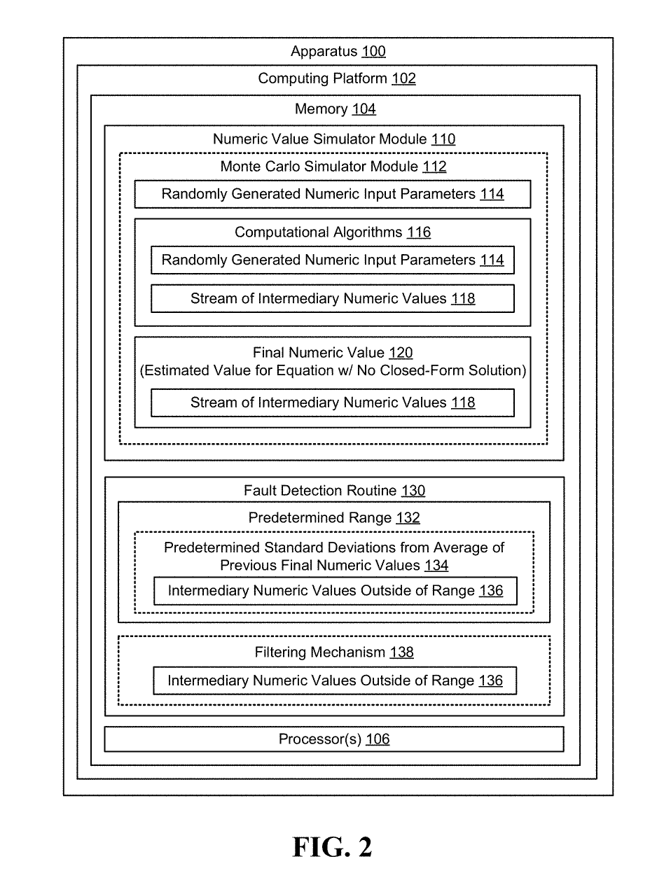

Referring to FIG. 2 a block diagram is depicted of an apparatus 100 configured for detecting and, in some embodiments, limiting or eliminating faults associated with numeric value simulation, in accordance with embodiments of the present invention. Apparatus 100 includes a computing platform 102 having a memory 104 and at least one processor 106 in communication with the memory 104. As previously noted, apparatus 100 may comprise multiple devices, such as multiple servers, storage devices, personal computers and the like.

Memory 104 may comprise volatile and non-volatile memory, such as read-only and/or random-access memory (RAM), read-only memory ROM, EPROM, EEPROM, flash cards, or any memory common to computer platforms. Further, memory 104 may include one or more flash memory cells, or may be any secondary or tertiary storage device, such as magnetic media, optical media, tape, or soft or hard disk. Moreover, memory 104 may comprise cloud storage, such as provided by a cloud storage service and/or a cloud connection service.

Further, processor 106 may be a Central Processing Unit (CPU), a Field Programmable Gate Array (FPGA), an application-specific integrated circuit (“ASIC”), or other chipset, processor, logic circuit, or other data processing device. Processor 106 or other processor, such as ASIC, may execute an application programming interface (“API”) (not shown in FIG. 2) that interfaces with any resident programs, modules or routines, such as numeric value simulator module 110, fault detection routine 130 and routines, sub-modules associated therewith or the like stored in memory 104 of apparatus 100. Processor 106 includes various processing subsystems (not shown in FIG. 2) embodied in hardware, firmware, software, and combinations thereof, that enable the functionality of apparatus 100 and the operability of the apparatus 100 on a computing network. For example, processing subsystems allow for initiating and maintaining communications and exchanging data with other networked computing platforms. For the disclosed aspects, processing subsystems of processor 106 may include any subsystem used in conjunction with numeric value simulator module 110 and/or fault detection routine 130 and related algorithms, sub-algorithms, modules, sub-modules thereof.

Computer platform 102 may additionally include a communications module (not shown in FIG. 2) embodied in hardware, firmware, software, and combinations thereof, that enables communications among the various components of the computing platform 102, as well as between the other networked devices. Thus, communication analysis module may include the requisite hardware, firmware, software and/or combinations thereof for establishing and maintaining a network communication connection.

Memory 104 stores numeric value simulator module 110. In specific embodiments of the invention, the numeric value simulator module is a Monte Carlo simulator module 112. The numeric value simulator module 110 is executable by one or more of processor(s) 106 and configured to receive randomly generated numeric input parameters 114. In those embodiments in which the numeric value simulator module 110 is being used to determine an estimated financial product price, the numeric input parameters 114 may be randomly generated by a Black-Scholes model or the like. The randomly generated numeric input parameters 114 are applied to one or more computational algorithm 116 which output a stream of intermediary numeric values 118. The stream of intermediary numeric values 118 are used to determine a final numeric value 120, which is an estimated value of the solution of an equation without using a closed-form solution. In specific embodiment the intermediary numeric values are averaged to determine the final numeric value 120.

Memory 104 of apparatus 100 additionally includes fault detection routine 130 which may be included within numeric value simulator module 110 or may be configured to run in conjunction with numeric value simulator module 110. Fault detection routine 130 and executable by one or more of processor(s) 106 is configured to determine/detect intermediary numeric values 136 that are outside of a predetermined range 132. In specific embodiments of the invention, the predetermined range 132 is further defined as a predetermined number of standard deviations 134 from average of previous final numeric values (i.e., previous executions/runs of the numeric value simulator module 110). Specifically, the number of standard deviations may be less than five, typically between three and five and, in one specific embodiment, five.

Moreover, according to specific embodiments of the invention, fault detection routine 130 may be configured to implement a filtering mechanism 138 to filter out the detected faults (i.e., the intermediary numeric values 136 that are outside of the predetermined range). In such embodiments of the invention, the filtering mechanism 138 is implemented prior to determining the final numeric value 120, for example, in specific embodiments, prior to averaging the intermediary numeric values 118 to result in the final numeric value 120. In this regard, by eliminating the faults prior to calculating the final numeric value 120 (i.e., the estimated solution to the equation), the final numeric value 120 is more accurate.

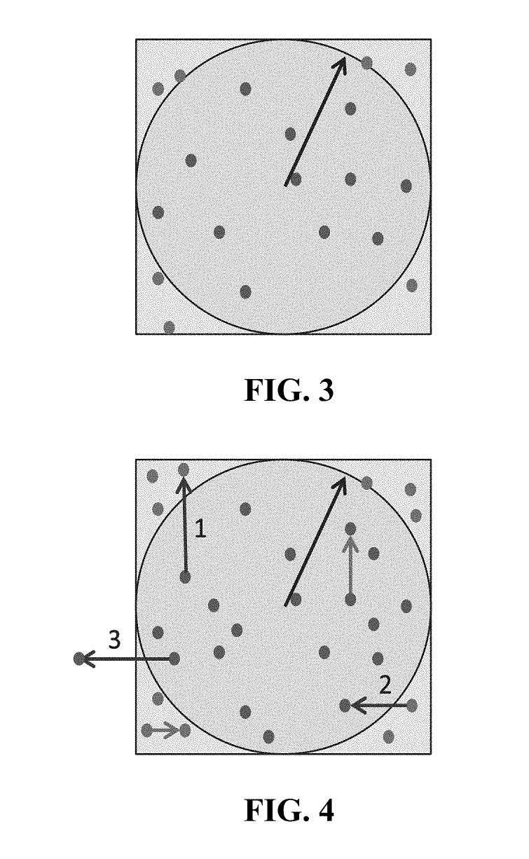

FIGS. 3 and 4 are graphical illustrations that highlight an example of a use of a numeric value simulator module, such as the Monte Carlo method simulator or the like in accordance with embodiments of the invention. In the illustrated example the equation without using a closed-form solution is the equation for pi (π). FIG. 3 shows a graphical plot 600 having a series of random coordinates 602 (i.e., randomly generated input parameters) some of which exist inside the circle 602A and some of which exist outside of the circle 602A. The ratio of coordinates inside the circle 602A to the total number of coordinates 602A and 602B converges to the value of pi (π). Table 1, shown below, illustrates that as the number of random coordinates 602 (i.e., randomly generated input parameters) inputted into the numeric value simulator module generally increases the accuracy of the calculated value for pi (π) generally increases.

TABLE 1

| Number of Random Coordinates | Pi (π) Value | Calculation Error |
|---|---|---|
| 1,000 | 3.176 | −0.0344073 |
| 10,000 | 3.1424 | −0.000807346 |
| 100,000 | 3.14604 | −0.00444735 |
| 1,000,000 | 3.14133 | 0.000260654 |
| 10,000,000 | 3.14156 | 0.0000366536 |
| 100,000,000 | 3.14165 | −0.0000617064 |

FIG. 4 illustrates the concept of faults being introduced into the numeric value simulator methodology. Arrow No. 1 indicates a fault in which the coordinates have moved from inside the circle to outside the circle, but still within an acceptable range (i.e., still within the x-y coordinate defined by the radius of the circle). In other words, the fault has resulted in the coordinates being calculated as being outside the circle when, in fact, the coordinates should have calculated as being inside the circle. Such a fault is viewed as undetectable and inconsequential as the overall error is proportional to the fault rate. Similarly, Arrow 2 indicates a fault in which the coordinates have moved from outside the circle, but still within the acceptable range, to inside the circle. In other words, the fault has resulted in the coordinates being calculated as being inside the circle when, in fact, the coordinates should have calculated as being outside the circle. Such a fault is also viewed as undetectable and inconsequential as the overall error is proportional to the fault rate. Arrow 3 indicates a fault in which the coordinates have moved from inside the circle (or inside the acceptable range as defined by the radius of the circle) to an outside of the acceptable range. Such faults are viewed as easily detectable and, as such are the faults which may be detected and filtered by the inventive concepts herein disclosed.

In the illustrated example discussed above and illustrated in FIGS. 3 and 4 the effect of faults on the solution to the equation (i.e., the value of pi (π)) is dependent upon (a) the number of faults; (b) data representation (e.g., fixed point, floating point, numerical range and the like); and (c) number of simulation trials.

In those instances in which a numeric value simulation, such as Monte Carlo simulation used for financial calculations, includes computational algorithms using floating point mathematics the faults resulting may indicate large errors (i.e., values significantly deviating from the norm). This is because floating point mathematics has a large dynamic range. Specifically, approximately 2⁸⁰ range for a single precision (32 bit) and approximately 2⁶⁰⁰ for double precision (64 bit). As such, some bits cause larger errors than other bits. For example, exponent errors can cause dramatic changes in the value being calculated. Faults in the streaming intermediary values that indicate large errors may result in dramatic errors in the final numeric value id such faults go undetected.

Numeric Value Simulation Trial

As a means of verifying the fault detection methodology of the present invention, trials were run using standard Monte Carlo computational algorithms. Single-bit faults (i.e., flip bit) were injected randomly into the results and the non-faulty results were compared to the fault-injected results. The fault rate was varied and the error measured. The fault detection was based on a predetermined range as defined by a predetermined number of standard deviations. Three scenarios were compared: (1) no faults injected; (2) faults injected with no fault detection/filtering; and (3) faults injected with fault detection/filtering, in accordance with embodiments of the present invention. Results of such trials showed that when faults were injected with no fault detection/filtering employed, even with relatively small error rates (i.e., smaller number of faults injected) dramatic errors/inaccuracies were encountered due to the floating point mathematics issue discussed above. Conversely, when faults were injected and fault detection/filtering employed, in accordance with embodiments of the present invention, the overall error/inaccuracy in the final numeric value was relatively small, even for relatively high error rates (i.e., larger number of faults injected).

Thus, systems, apparatus, methods, and computer program products described above provide for limiting faults, and in some instances eliminating faults, that exist within a random sampling simulation method for determining numeric results, such as, for example, the Monte Carlo simulation method. By introducing fault detection within the process itself, faults can be lessened or eliminated without having to implement cost-prohibitive additional hardware, in the form of redundant circuitry, ECC or the like. In this regard, the invention provides for detecting faults during the simulation process prior to determining the estimated numerical value of an equation without using a closed-form solution. Specifically, filtering out determined intermediary numerical values, which are subsequently the basis for the estimated numerical value, that are outside of a predetermined range, for example a predetermined number of standard deviations away from the averaging of historical estimated numerical values (i.e., results of previous simulation runs).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for detecting faults associated with random sampling to obtain a numeric value, the system comprising:
a computing platform having a memory and at least one processor in communication with the memory;
a numeric value simulator module stored in the memory, executable by the processor and configured to:
receive a plurality of randomly generated numerical input parameters;
apply the plurality of randomly generated numerical input parameters to one or more computational algorithms to determine a plurality of intermediary numeric values;
determining a final numeric value based on the plurality of intermediary numeric values, wherein the final numeric value is an estimated value for an equation without using a closed-form solution; and
a fault detection routine stored in the memory, executable by the processor and configured to determine one or more of the plurality of intermediary numeric values that are outside of a predetermined range, wherein each of the intermediary numeric values that are outside of a predetermined range define a fault.

2. The system of claim 1, wherein the numeric value simulator module is further defined as a Monte Carlo method simulator module.

3. The system of claim 1, wherein the fault detection routine is further configured to filter out the determined intermediary numeric values that are outside of the predetermined range prior to determining the final numeric value.

4. The system of claim 1, wherein the fault detection routine is further configured to determine the one or more of the plurality of intermediary numeric values that are outside of the predetermined range, wherein the predetermined range is based on a predetermined number of standard deviations from a historical averaging of final numeric values.

5. The system of claim 4, wherein the fault detection routine is further configured to determine the one or more of the plurality of intermediary numeric values that are outside of the predetermined range, wherein the predetermined range is based on the predetermined standard deviations from the historical averaging of final numeric values, wherein the predetermined number of standard deviations is less than or equal to five standard deviations.

6. The system of claim 1, wherein the numeric value simulator module is further configured to:
receive a plurality of randomly generated numerical input parameters, wherein the input parameters are parameters that effect pricing of a predetermined financial options;
apply the plurality of randomly generated numerical input parameters to one or more computational algorithms to determine a plurality of intermediary numeric values;
determine the final numeric value based on the plurality of intermediary numeric values, wherein the final numeric value is further defined as an estimated price for the predetermined financial option.

7. The system of claim 6, further comprising a financial option transaction module stored in the memory, executable by the processor and configured to, in automatic response to determining the estimated price for the predetermined financial option, conduct a sale of the financial option based on the estimated price for the predetermined financial option.

8. The system of claim 1, further comprising a detected fault database configured to, in response to determining that one or more of the plurality of intermediary numeric values are outside of the predetermined range, receive and store information associated the one or more of the plurality of intermediary numeric values that are outside of the predetermined range.

9. The system of claim 8, further comprising a fault-related reporting module stored in the memory, executable by the processor and configured to access the detected fault database to retrieve the information and generate and initiate electronic communication of a plurality of graphical data based on the information.

10. The system of claim 1, further comprising a fault analysis module stored in the memory, executable by the processor and configured to:
receive results from the numeric value simulator module and the fault detection routine, wherein the results include, for each process conducted by the numeric value simulator module, the intermediary numeric values that are outside of the predetermined range; and
analyze the results to determine one or more trends in the intermediary numeric values that are outside of the predetermined range.

11. The system of claim 10, wherein the fault analysis module is further configured to determine a fault type based on at least one of the one or more trends in the intermediary numeric values that are outside of the predetermined range, wherein the fault types include, at least, a communication network fault, a hardware fault and a human error fault.

12. The system of claim 1, further comprising a fault analysis module stored in the memory, executable by the processor and configured to:
receive to results for the numeric value simulator module and the fault detection routine, wherein the results include, for each process conducted by the numeric value simulator module, the intermediary numeric values that are outside of the predetermined range; and
analyze the results to determine a fault source for at least one of the intermediary numeric values that are outside of the predetermined range, wherein the fault source comprises a specific computing device used by the numeric value simulator module.

13. A method for detecting faults associated with random sampling to obtain a numeric value, the method comprising:
receiving, by a computing device processor, a plurality of randomly generated numerical input parameters;
applying, by a computing device processor, the plurality of randomly generated numerical input parameters to one or more computational algorithms to determine a plurality of intermediary numeric values;
determining, by a computing device processor, one or more of the plurality of intermediary numeric values that are outside of a predetermined range, wherein each of the intermediary numeric values that are outside of a predetermined range define a fault; and
determining, by a computing device processor, a final numeric value based on the plurality of intermediary numeric values, wherein the final numeric value is an estimated value for an equation without using a closed-form solution.

14. The method of claim 14, wherein applying the plurality of randomly generated numerical input parameters to one or more computational algorithms further comprises applying, by the computing device processor, the plurality of randomly generated numerical input parameters to one or more computational algorithms, wherein the computational algorithms are Monte Carlo method computational algorithms.

15. The method of claim 14, further comprising filtering out, by a computing device processor, the determined one or more of the plurality of intermediary numeric values prior to determining the final numeric value.

16. The method of claim 14, wherein determining the one or more of the plurality of intermediary numeric values that are outside of the predetermined range further comprises determining, by a computing device processor, the one or more of the plurality of intermediary numeric values that are outside of the predetermined range, wherein the predetermined range is based on a predetermined number of standard deviations from a historical averaging of final numeric values.

17. A computer program product including a non-transitory computer-readable medium, the computer-readable medium comprising:
a first set of codes for causing a computer to receive a plurality of randomly generated numerical input parameters;
a second set of codes for causing a computer to apply the plurality of randomly generated numerical input parameters to one or more computational algorithms to determine a plurality of intermediary numeric values;
a third set of codes for causing a computer to determine, one or more of the plurality of intermediary numeric values that are outside of a predetermined range, wherein each of the intermediary numeric values that are outside of a predetermined range define a fault; and
a fourth set of codes for causing a computer to determine a final numeric value based on the plurality of intermediary numeric values, wherein the final numeric value is an estimated value for an equation without using a closed-form solution.

18. The computer program product of claim 17, wherein the second set of codes is further configured to cause the computer to apply the plurality of randomly generated numerical input parameters to one or more computational algorithms, wherein the computational algorithms are Monte Carlo method computational algorithms.

19. The computer program product of claim 17, further comprising a fourth set of codes for causing a computer to filter out the determined one or more of the plurality of intermediary numeric values prior to determining the final numeric value.

20. The computer program product of claim 17, wherein the third set of codes is further configured to cause the computer to determine the one or more of the plurality of intermediary numeric values that are outside of a predetermined range, wherein the predetermined range is based on a predetermined number of standard deviations from a historical averaging of final numeric values.
